(19) United States
(12) Patent Application Publication
(10) Pub. No.: US 2007/0058190 A1
(43) Pub. Date: Mar. 15, 2007

(54) Multi-function printer

(75) Inventor: Tamura Harumichi, Souraku-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/518,120

(22) Filed: Sep. 11, 2006

(30) Foreign Application Priority Data
Sep. 13, 2005 (JP) 2005-265893

(51) Int. Cl. G06F 3/12

(52) U.S. Cl. 358/1.13; 358/1.14

(57) ABSTRACT

The present invention intends to reduce standby power consumption in a multi-function printer which can be connected to an external device. The multi-function printer has user setting information 11b which can be changed by a user and in a power saving mode, a power supply unit 3 interrupts a power supply to a modem 14, a scanner 15, a printer 16 and a back light of a display unit 17 and the like, and also interrupts a power supply to an external interface unit 2 on the basis of the user setting information 11b. On the basis of detection results of connection detection units 21d and 22d for detecting the connecting state to a PC 102, the user setting information 11b is automatically changed so that the power supply to the external interface unit 2 in the subsequent power saving mode may not be interrupted. During connection to the PC, a changing operation of the user setting information 11b by the user is restricted.

### BACKGROUND OF THE INVENTION

1. Field of the Invention

The present invention relates to a multi-function printer, in particular, improvement in a multi-function printer which can be independently used as a facsimile machine and also can be used as peripheral equipment of the information processing device when being connected to the information processing device such as a personal computer.

2. Description of the Related Art

Generally, a facsimile machine is composed of a modem unit for transmitting/receiving image information via a public communication line, a scanner unit for optically reading the image information from a paper medium and a printer unit for recording the image information on the paper medium. At the time of facsimile transmission, document information read from the paper medium by the scanner unit is transmitted to the public communication line through the modem unit. At the time of facsimile reception, document information received by the modem is recorded on the paper medium by the printer.

Since facsimile reception is activated by arrival of the incoming signal from the other facsimile machine, time of facsimile reception cannot be forecasted on the arrival side. For this reason, the facsimile machine needs to keep a state where the facsimile reception can be started at any time during standby. Since the standby time is far longer than the facsimile reception time, average power consumption in the facsimile machine is greatly influenced by standby power consumption. Therefore, for the facsimile machine, an important object is to reduce standby power consumption.

In consideration of such circumstances, the conventional facsimile machine has an operation mode with low power consumption, which is called as a “power saving mode” and the power consumption is cut by changing the operation mode to the power saving mode during standby (for example, Patent document 1). In a facsimile machine disclosed in Patent document 1, the normal power mode and the power saving mode can be switched to each other and in the power saving mode, power supplied to an area other than an area necessary for return to the normal power mode is reduced.

Next, the recent facsimile machines, when being connected to a personal computer (hereinafter referred to as a PC), can be often used as peripheral devices of the PC, such as printers or scanners. Such facsimile machines are called as multi-function printers.

The multi-function printer has an external interface unit for connecting the PC therein and based on a request from the PC, operates internal printer and scanner. Thus, when the multi-function printer is connected to the PC, power needs to be supplied to the external interface unit at all time whether the operating mode is the normal power mode or the power saving mode.

On the other hand, when the multi-function printer is connected to the PC, a power supply to the external interface unit can be interrupted. Even in such case, however, if the user connects the multi-function printer to the PC, it is necessary to start the power supply to the external interface unit. Thus, in the conventional general multi-function printer, power is supplied to the external interface unit at all times. As a result, even when the PC is not connected and the operating mode is the power saving mode, power is disadvantageously consumed in the external interface unit at any time, thereby increasing the standby power consumption of the facsimile machine.

Therefore, a facsimile machine has been proposed in which power is supplied to the external interface unit according to the connecting state to the PC (for example, Patent document 2). The multi-function printer disclosed in the patent document 2 has a V-bus detection circuit for monitoring a V-bus signal of a USB connector and detecting the PC connecting state and interrupts a power supply to the USB controller when the PC is not connected. In this multi-function printer, although power consumption in the USB controller can be reduced when the PC is not connected, power needs to be supplied to the V-bus detection circuit at all times.

Patent document 1: Japanese Unexamined Patent Publication No. 2005-035255

Patent document 2: Japanese Unexamined Patent Publication No. 2004-130561

### SUMMARY OF THE INVENTION

In consideration of the above-mentioned circumstances, an object of the present invention is to reduce power consumption in a multi-function printer which can be connected to an external device during standby. Especially, another object of the present invention is to reduce power consumption in a power saving mode according to a usage manner of the user in a multi-function printer which automatically switches between a normal power mode and a power saving mode. Still another object of the present invention is to provide a multi-function printer having good operability.

According to a first aspect of the present invention, a multi-function printer has at least two operation modes different in power consumption and can be connected to an external device. The multi-function printer includes a facsimile communication unit for receiving facsimile communication information via a public communication line, an external interface unit for receiving a request signal from the external device, a power supply unit for supplying power to the facsimile communication unit and the external interface unit, and a user setting storage unit for storing user setting information which can be changed by an operation of a user. The power supply unit is configured so as to interrupt a power supply to the facsimile communication unit on the basis of the operation mode being selected as a current operation mode and interrupt the power supply to said external interface unit on the basis of the current operation mode and the user setting information.

With such configuration, the power supply to the facsimile communication unit is interrupted on the basis of the current operation mode, while the power supply to the external interface unit is interrupted on the basis of the user setting information which can be changed by the user in addition to the current operation mode. Thus, the power consumption can be reduced according to the usage manner of the multi-function printer by the user. The user himself/herself can select whether or not such reduction in power consumption is performed.

The multi-function printer from a second aspect of the present invention is configured furthermore so that the operation modes are comprised of a normal power mode and a power saving mode, and the power supply unit interrupts the power supply to the facsimile communication unit in the power saving mode and interrupts the power supply to the external interface unit on the basis of the user setting information in the power saving mode.

With such configuration, in the power saving mode for interrupting the power supply to the facsimile communication unit, the power supply to the external interface unit can be interrupted on the basis of the user setting information Therefore, according to the usage manner of the user, the power consumption in the power saving mode can be reduced.

The multi-function printer from a third aspect of the present invention is configured furthermore so that the external interface unit has a connection detection unit for detecting the connecting state of the external device, and the power supply unit interrupts a power supply to the external interface unit in the subsequent power saving mode on the basis of detection result of the connection detection unit in the normal power mode.

With such configuration, on the basis of the detection result on the connecting state of the external device in the normal power mode, the power supply to the external interface unit in the subsequent power saving mode can be interrupted. Thus, according to the connecting state of the external device, power consumption in the power saving mode can be reduced.

The multi-function printer from a fourth aspect of the present invention is configured furthermore so that the user setting storage unit stores user setting information representing un-connection of the external device as a usage manner of a user, the power supply unit interrupts the power supply to the external interface unit in the power saving mode and when the user setting information is set, and the user setting information is reset when connection to the external device is detected by the connection detection unit in the normal power mode.

With such configuration, even when the user setting information is set, if the connecting state of the external device is detected, the user setting information is automatically reset so that the power supply to the external interface unit in the subsequent power saving mode may not be interrupted. Therefore, even when the user does not change the user setting information, the multi-function printer can communicate with the external device in the power saving mode, thereby improving operability of the multi-function printer.

The multi-function printer from a fifth aspect of the present invention is configured furthermore so that the user setting storage unit stores user setting information representing un-connection of the external device as a usage manner of the user, the power supply unit interrupts the power supply to the external interface unit in the power saving mode and when the user setting information is set, and a setting operation of the user setting information by the user is prohibited when a connection to the external device is detected by the connection detection unit.

With such configuration, when the external device is connected, it is possible to prevent the user from setting the user setting information by mistake and prevent the user from wrongly operating so that communication with the external device cannot be performed in the power saving mode.

According to the present invention, it is possible to reduce power consumption in the multi-function printer which can be connected to the external device during standby. Especially in the multi-function printer having the normal power mode and the power saving mode, power consumption in the power saving mode can be reduced according to the usage manner of the user. Furthermore, a multi-function printer with good operability can be provided.

The above and further objects and novel features of the invention will more fully appear from the following detailed description when the same is read in connection with the accompanying drawings. It is to be expressly understood, however, that the drawings are for purpose of illustration only and are not intended as a definition of the limits of the invention.

### BRIEF DESCRIPTION OF THE DRAWINGS

FIG. 1 is an interrupt diagram showing one example of configuration of a multi-function printer in accordance with an embodiment of the present invention;

FIG. 2 is an interrupt diagram showing an example of detailed configuration of an external interface unit 2 in FIG. 1;

FIGS. 3A to 3C are views showing examples of the usage manner of the multi-function printer 100;

FIG. 4 is an explanation view of a power supply operation to an external interface unit 2;

FIG. 5 is a flow chart showing an example of power supply control to the external interface unit 2 at the time of switching the operation mode;

FIG. 6 is a flow chart showing an example of an operation when the connecting state of a PC changes; and

FIG. 7 is a flow chart showing an example of an operation when the user setting information changes

### DESCRIPTION OF THE PREFERRED EMBODIMENT

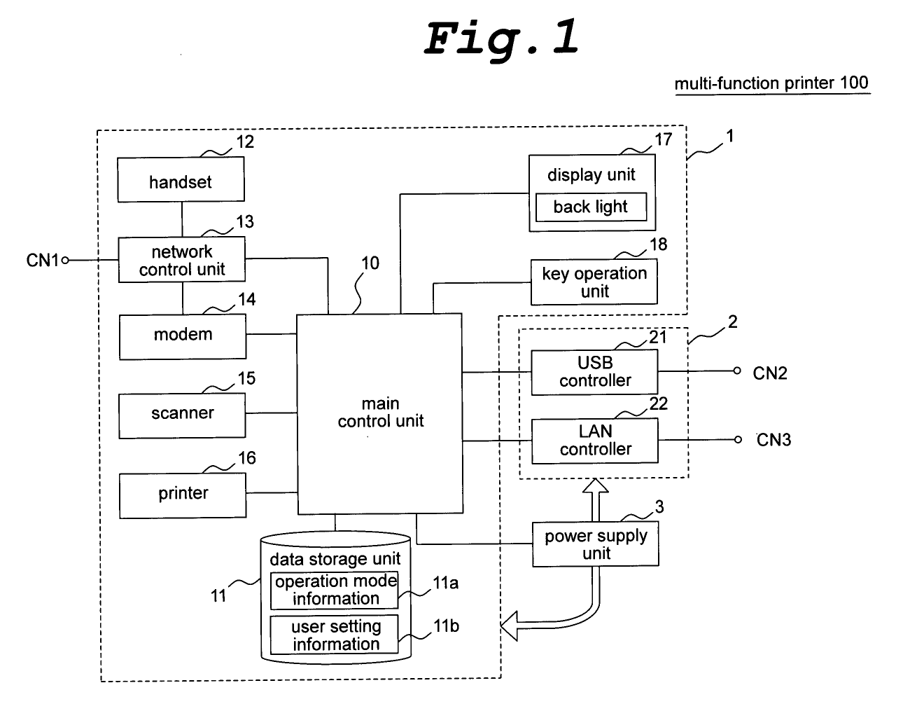

FIG. 1 is an interrupt diagram showing an example of configuration of a multi-function printer in accordance with an embodiment of the present invention. This multi-function printer 100 is composed of a facsimile main unit 1, an external interface unit 2 and a power supply unit 3.

The facsimile main unit 1 is connected to the public communication line via a telephone line connector CN1 and can transmit/receive document information to/from the other facsimile machine not shown (facsimile transmission). The external interface unit 2 is an interface circuit connected to an information processing device such as a PC via a USB (Universal Serial Bus) connector CN2 or a LAN (Local Area Network) connector CN3. The power supply unit 3 is a power source circuit for supplying power to the facsimile main unit 1 and the external interface unit 2.

Given that the telephone line connector CN1 is connected to the telephone line, even if the USB connector CN2 or the LAN connector CN3 is not connected to the PC, the multi-function printer 100 can carry out facsimile transmission. If connected to the PC, the multi-function printer 100 can be also used as a peripheral device. That is, the multi-function printer 100 can be used as a printer or scanner for the PC as necessary.

The facsimile main unit 1 has two operation modes different in power consumption, that is, a normal power mode and a power saving mode. These operation modes are automatically switched therebetween. The power saving mode is an operation mode of supplying power to only minimum necessary components among components forming the facsimile main unit 1 and has lower power consumption than the normal power mode.

On the other hand, a power supply to the external interface unit 2 is performed on the basis of the operation mode and user setting information. More specifically, when the facsimile main unit 1 is in the power saving mode and the user already has set that the PC is not connected (PC unconnected setting), the power supply to the external interface unit 2 is interrupted and in the other cases, the power supply is performed. Thus, in the power saving mode, the user selects whether or not power is supplied to the external interface unit 2.

The illustrated facsimile main unit 1 is composed of a main control unit 10, a data storage unit 11, a handset 12, a network control unit 13, a modem 14, a scanner 15, a printer 16, a display unit 17 and a key operation unit 18.

The main control unit 10 is a micro processor which controls main operations of the multi-function printer 100. The main control unit 10 controls operations of the facsimile main unit 1 as well as the external interface unit 2 and the power supply unit 3.

The data storage unit 11 is a memory which stores a program and data used by the main control unit 10 therein, here, a nonvolatile memory which rewritably holds at least an operation mode information 11a and the user setting information 11b. The operation mode information 11a holds the normal power mode or the power saving mode as the current operation mode and is automatically updated by the main control unit 10. The user setting information 11b is data for previously registering usage manner for each user. Here, the user setting information 11b consists of 1 bit of flag data representing the usage manner in which the PC is not connected to the multi-function printer 100 temporarily or continuously. The main control unit 10 controls the power supply unit 3 on the basis of the operation mode information 11a and the user setting information 11b.

The network control unit 13 switches the handset 12 or the modem 14 to be connected to the telephone line connector CN1. That is, at the time of off-hook, the handset is connected to the public communication line and at the time of facsimile transmission, the modem 14 is connected to the public communication line. When an incoming signal is detected from the public communication line, the network control unit 13 outputs an incoming signal detection signal to the main control unit 10 to inform arrival of the incoming signal.

The modem 14 is a facsimile communication unit for performing facsimile transmission through the network control unit 13. That is, at the time of facsimile transmission, the modem 14 encodes an image read by the scanner 15 and sends the encoded image to the public communication line as facsimile communication information. At the time of facsimile reception, the facsimile communication information received from the public communication line is decoded and the decoded information is output to the printer 16 as a printed image.

The scanner 15 is an optical reader for optically reading image information recorded on a paper medium. For example, the scanner 15 irradiates the paper medium with light and reads the reflected light by using a line sensor or the like. The printer 16 is a recorder for recording image information on a paper medium. The recorder can adopt, for example, a thermal method, a thermal transfer method and an ink jet method.

The display unit 17 is a means for displaying operating state of the multi-function printer 100 and the like thereon to the user and configured of a liquid crystal display panel and a backlight. The key operation unit 18 is a means for doing input by the user and is configured of operational keys such as a ten key and a start button. The user can operate the key operation unit 18 while seeing the display unit 17 to change the above-mentioned user setting information 11b.

The external interface unit 2 is configured of a USB controller 21 and a LAN controller 22. The USB controller 21 is an interface circuit connected to the USB connector CN2 and an information processing device such as a PC is detachably connected to the USB connector CN2 via a cable. In a similar manner, the LAN controller 22 is an interface circuit connected to the IAN connector CN3 and an information processing device such as a PC is detachably connected to the LAN connector CN3 via the cable.

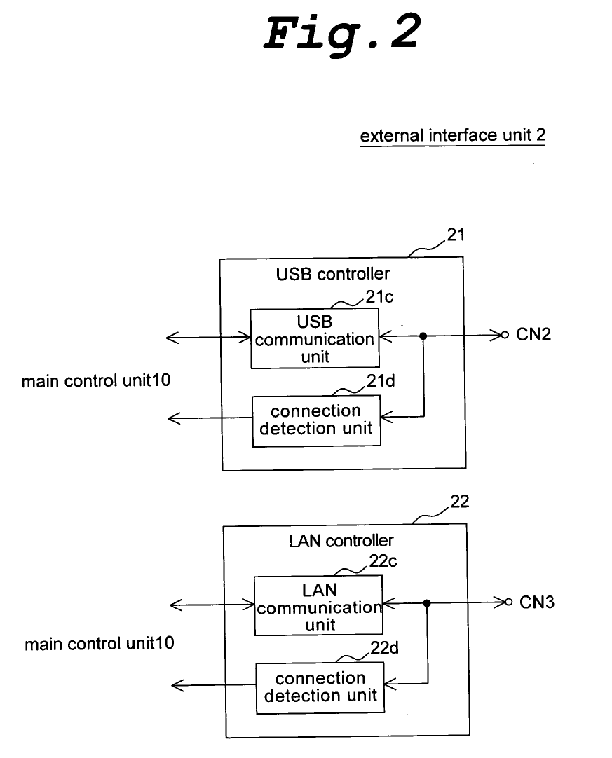

FIG. 2 is an interrupt diagram showing detailed configuration of the external interface unit 2 in FIG. 1. The USB controller 21 is composed of a USB communication unit 21c for transmitting/receiving a signal to/from the PC and a connection detection unit 21d for detecting the connecting state of the PC. When the user attaches/detaches PC to/from the USB connector CN2, the connection detection unit 21d detects the attaching/detaching operation and informs the main control unit 10 of the operation. Similarly, the LAN controller 22 is composed of a LAN communication unit 22c for transmitting/receiving a signal to/from the PC and a connection detection unit 22d for detecting the connecting state of the PC.

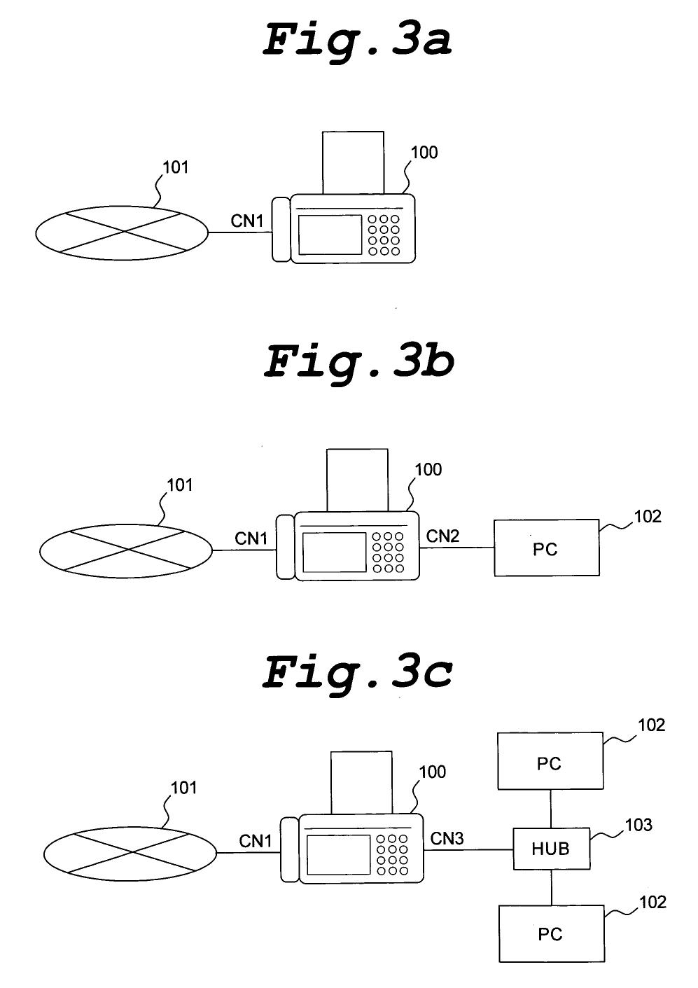

FIGS. 3A to 3C are views showing examples of the usage manner of the multi-function printer 100. FIG. 3A shows the mode in which the multi-function printer 100 is connected to the public communication line 101 and is independently used as a facsimile machine. FIG. 3B shows the mode in which the multi-function printer 100 is connected to a PC 102 via a USB cable and used as a facsimile machine as well as a printer (so-called local printer) for the PC 102. FIG. 3C shows the mode in which the multi-function printer 100 is connected to two or more PCs 102 via a IAN cable and a HUB (line concentrator) 103 and used. That is, the multi-function printer 100 is independently used as the facsimile machine and also used as a printer (so-called network printer) by use of two or more PCs 102 via a network. It is needless to say that a usage manner in which the multi-function printer 100 is connected to one PC 102 via the LAN cable can be adopted.

In the case of the multi-function printer for domestic use, it is deemed that a largest number of users use the usage manner as shown in FIG. 3A and less number of users use the usage manners as shown in FIG. 3B and FIG. 3C with less frequency. Thus, the multi-function printer 100 in the present embodiment is configured so as to interrupt the power supply to the external interface unit 2 in the power saving mode according to the user setting.

In the case of connecting mode as shown in FIG. 3C, the connection detection unit 22d detects that the LAN connector CN3 of the multi-function printer 100 is connected to the HUB 103 and the detection result can be used as the connecting state of the PC 102.

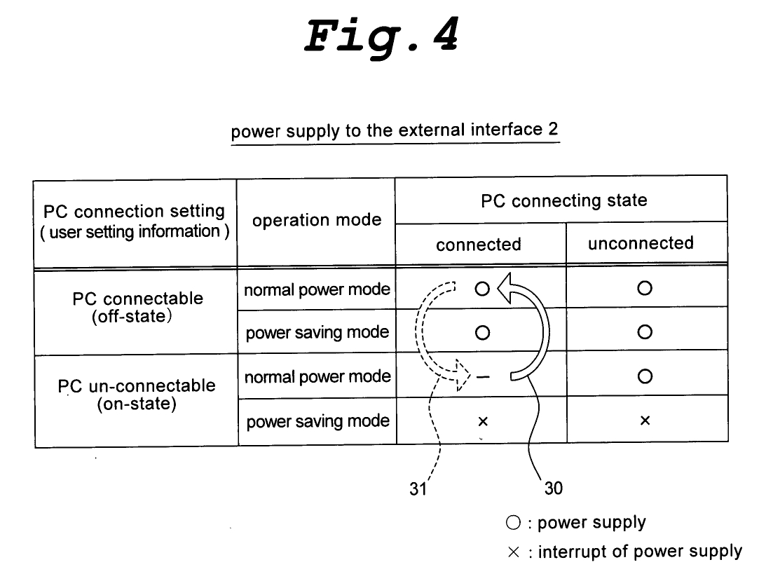

FIG. 4 is an explanation view of the power supply operation to the external interface unit 2. In the figure, mark O indicates that power is supplied to the external interface unit 2, mark X indicates that power supply is interrupted and a mark - indicates that the state does not exist. A solid arrow 30 shows automatic transition and a broken arrow 31 shows prohibited transition.

“PC connection setting” in the figure is the usage manner of the multi-function printer 100, which is designated by the user as the user setting information 11b. “PC connectable” is the usage manner in which the PC is connected or can be connected, and in this usage manner, the user previously resets the user setting information 11b to be in the off-state. On the other hand, “PC un-connectable” is the usage manner in which the PC is not connected temporarily or continuously and in this usage manner, the user previously resets the user setting information 11b to be in the on-state.

The “Operation mode” in the figure is the current operation mode of the multi-function printer 100, which is represented by the operation mode information 11a, that is, the normal power mode or the power saving mode. The “PC connecting state” is the PC connecting state at the present time and is detected by the connection detection units 21d and 22d. “Connected” indicates the state where the USB controller 21 or the LAN controller 22 is connected to the PC and “Unconnected” indicates the state where both the USB controller 21 and the LAN controller 22 are not connected to the PC.

As shown by the marks O in FIG. 4, in the case where the PC connection setting is set as “PC connectable” and the case where the current operation mode is the normal power mode, power is supplied to the external interface unit 2. That is, either of the conditions is met, power is supplied to the USB controller 21 and the LAN controller 22 so enables communication with the PC. On the other hand, as shown by the mark X, in the case where the PC connection setting is set as “PC un-connectable” and the case where the current operation mode is the power saving mode, the power supply to the external interface unit 2 is interrupted.

During interruption of power supply to the external interface unit 2, the multi-function printer 100 cannot communicate with the PC, for example, cannot receive a printing request from the PC. However, power consumption in the external interface unit 2 can he reduced. Here, interruption of power supply to the external interface unit 2 means interruption of a power supply to the USB communication unit 21c and the LAN communication unit 22c as well as the connection detection units 21d and 22d.

When the connection detection unit 21d or 22d detects connection with the PC in the normal power mode, if the user setting information 11b is the on-state (PC un-connectable), the connecting state is automatically changed to the off-state (PC connectable) by the main control unit 10. That is, the transition shown by the solid arrow 30 in FIG. 4 is automatically carried out. In this manner, by automatically changing the user setting information 11b on the basis of the detection result of the PC connecting state, even when the current operation mode is changed to the power saving mode after that, the power supply to the external interface unit 2 is not interrupted.

Furthermore, when the connection detection unit 21d or 22d detects connection with the PC, the user is prohibited from changing the user setting information 11b to the on-state (PC un-connectable). That is, the transition shown by the broken arrow 31 in FIG. 4 is prohibited. Thus, it is possible to prevent the user from rewriting the user setting information 11b by mistake so that communication with the PC cannot be performed in the subsequent power saving mode.

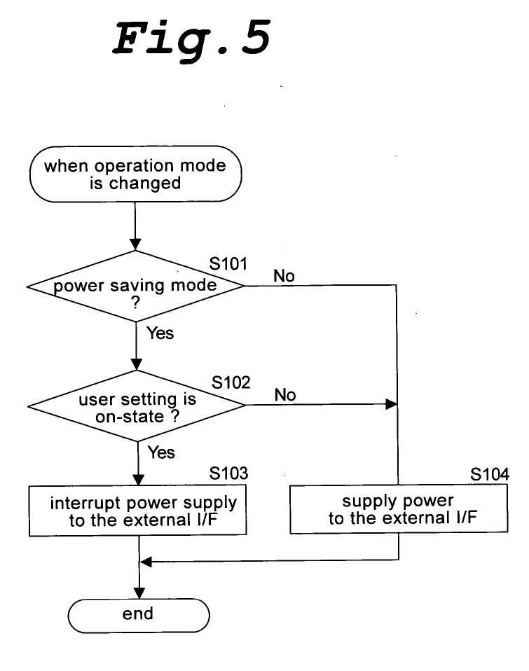

FIG. 5 consisting of steps S101 to S104 is a flow chart showing an example of control on the power supply to the external interface unit 2 at the time to switch the operation mode, and shows processing to be performed by the main control unit 10. When it is determined that the multi-function printer 100 continues the idling state for a predetermined period, the current operation mode moves to the power saving mode. Then, when the idling state is finished, the current operation mode returns to the normal power mode. Such switching control of the operation mode is carried out by the main control unit 10.

Specifically, in the normal power mode, when the idling state in which the multi-function printer 100 waits for triggers such as facsimile transmission, a request from the PC, an operation of the user continues for a certain period, the main control unit 10 rewrites the operation mode information 11a to the power saving mode and allows the current operation mode to move to the power saving mode. In the power saving mode, a power supply to the back light of the display unit 17, the modem 14, the scanner 15 and the printer 16 is interrupted, clock frequency of the main control unit 10 is lowered and power consumption in the multi-function printer 100 is greatly reduced. In this power saving mode, when triggers to terminate the idling state, such as arrival of the incoming signal from the public communication line, receipt of the signal from the PC and the user operation, are given from the outside, the main control unit 10 rewrites the operation mode information 11a to the normal power mode and allows the current operation mode to return to the normal power mode.

When such mode switching is performed, the main control unit 10 controls the power supply to the external interface unit 2 on the basis of the user setting information 11b. That is, in the case where the normal power mode is switched to the power saving mode (step S101) and the user setting information is the on-state (PC un-connectable) (step S102), the main control unit 10 instructs the power supply unit 3 to interrupt the power supply to the external interface unit 2 (step S103). In the other cases, the power supply unit 3 supplies power to the external interface unit 2 (step S104).

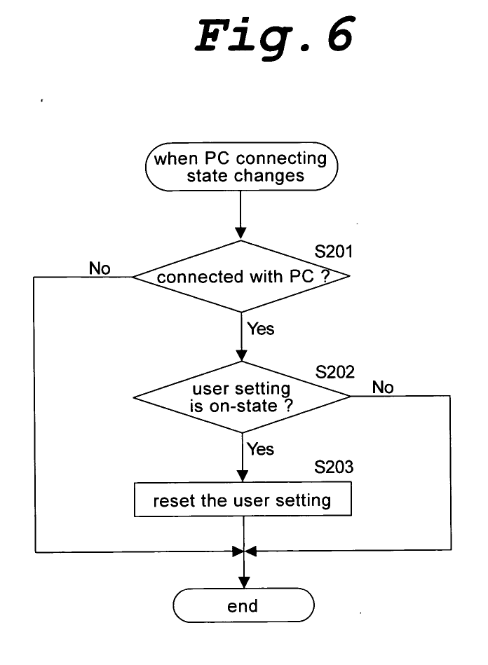

FIG. 6 consisting of steps S201 to S203 is a flow chart showing one example of the behavior when the PC connecting state changes. This flow chart shows processing which is executed by the main control unit 10 in the normal power mode and started when the detection result in the connection detection units 21d, 22d changes.

First, in the case where connection with the PC is released, the processing is finished (step S201). Furthermore, in the case where the user setting information 11b is the off-state (PC connectable), the processing is finished (step S202). On the other hand, in the case where the multi-function printer 100 is connected to the PC even when the user setting information 11b is the on-state (PC un-connectable), the main control unit 10 resets the user setting information 11b to be changed to the off-state (step S203). That is, in the case where the multi-function printer 100 is connected to the PC, when the user setting information 11b is the on-state, the user setting information 11b is automatically reset. Thus, the user need not make a reset operation. For this reason, even the user who is not accustomed to operating the multi-function printer can make full use of it without requiring any complicated setting operation.

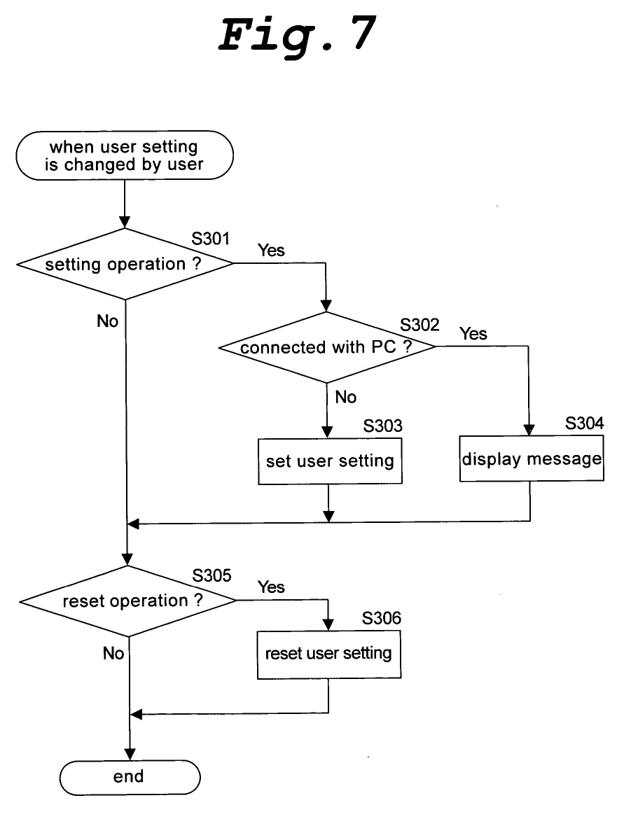

FIG. 7 consisting of steps S301 to S306 is a flow chart showing an example of the behavior when the user setting information 11b changes. This flow chart shows processing executed by the main control unit 10.

When the user performs the setting operation of the user setting information 11b, the main control unit 10 sets the user setting information 11b on the basis of the detection result of the connection detection units 21d, 22d (steps S301 to S304). That is, when the PC is not connected, the user setting information 11b is changed to the on-state and when the PC is connected, the user setting information 11b is not changed to the on-state and allows the display unit 17 to display a message representing that setting of the user setting information 11b is prohibited thereon.

On the other hand, when the user performs the reset operation of the user setting information 11b, the main control unit 10 resets the user setting information 11b (steps S305, S306).

In this embodiment, according to the usage manner of the user, on the basis of the user setting information 11b designated by the user, the power supply to the external interface unit 2 in the power saving mode is interrupted. That is, in the usage manner of connecting to the PC, the power supply is performed even in the power saving mode, and in the usage manner not connecting to the PC, the power supply can be interrupted in the power saving mode. In this manner, by interrupting the power supply to the external interface unit 2 according to the usage manner of each user, power consumption in the multi-function printer which can be connected to the PC in the power saving mode can be reduced.

For example, in the conventional multi-function printer, power consumption in the normal power mode is 10 W or more, power consumption in the power saving mode is about 5 W whether the PC is connected or not. On the contrary, in the multi-function printer 100 in the present embodiment, since the power supply to the external interface unit 2 can be interrupted as long as the user adopts the usage manner in which the PC is not connected, power consumption in the power saving mode can be reduced to about 2 W.

In the present embodiment, in the state where the external interface unit 2 monitors the PC connecting state and the PC is newly connected, when the user setting information 11b is the on-state (PC un-connectable), the user setting information 11b is automatically changed to the off-state (PC connectable) and then, the transition to the power saving mode prevents the power supply to the external interface unit 2 from being interrupted. Thus, the user need not change the user setting information 11b in connecting to the PC, thereby enabling improvement in operability. Moreover, in the usage manner in which the PC is connected, even when the user sets the user setting information 11b wrongly, no problem occurs.

For example, when the machine is shipped to the factory with the user setting information 11b being set on-state, if the user who purchases the multi-function printer 100 does not connect it to the PC, the user setting information 11b is kept on-state. On the other hand, when the user connects it to the PC, the user setting information 11b is automatically reset to be off-state. Thus, in the power saving mode, it is possible to determine which of communication with the PC or reduction in power consumption takes precedence according to the usage manner of the user.

However, even when connection to the PC is released, the user setting information 11b is not automatically reset. When the user setting information 11b is automatically set, even if the user connects the multi-function printer to the PC, the machine cannot communicate with the PC as long as the current operation mode is the power saving mode. In other words, although the user setting information 11b is automatically reset, it is not automatically set and the user must set the user setting information 11b for himself/herself.

In the present embodiment, when the user changes the user setting information 11b from the off-state (PC connectable) to the on-state (PC un-connectable), if the PC is connected, the changing operation is made invalid. For this reason, it is possible to prevent the user from changing the user setting information 11b by mistake.

In the present embodiment, the two controllers 21 and 22 forming the external interface unit 2 together control the power supply are explained. However, the present invention is not limited to this case. That is, the external interface unit 2 may be configured of one controller 21 and even when the external interface unit 2 is configured of two or more controllers 21, 22, each controller 21, 22 may independently detect the PC connecting state and control the power supply.

Furthermore, in the present embodiment, the PC is connected via the USB controller 21 and the LAN controller 22 are explained. However, the present invention is not limited to this case. That is, the external device is detachably connected to the multi-function printer and as long as connection to the external device can be detected, the external device may be an information processing device other than the PC. An interface between the multi-function printer and the external device may be any component other than USB and LAN.

The entire disclosure of a Japanese Patent Application No. 2005-265893 (filed on Sep. 13, 2005) including specification, claims, drawings and summary, on which the Convention priority of the present application is based, are incorporated herein by reference in its entirety.

What is claimed is:

1. A multi-function printer which has at least two operation modes different in power consumption and can be connected to an external device, comprising:
a facsimile communication unit for receiving facsimile communication information via a public communication line;
an external interface unit for receiving a request signal from said external device;
a power supply unit for supplying power to said facsimile communication unit and said external interface unit; and
a user setting storage unit for storing user setting information which can be changed by an operation of a user, wherein
said power supply unit interrupts a power supply to said facsimile communication unit on the basis of said operation mode being selected as a current operation mode and interrupts a power supply to said external interface unit on the basis of said current operation mode and said user setting information.

2. The multi-function printer according to claim 1, wherein
said operation modes include a normal power mode and a power saving mode, and
in the power saving mode, said power supply unit interrupts the power supply to said facsimile communication unit and interrupts the power supply to said external interface unit on the basis of said user setting information.

3. The multi-function printer according to claim 2, wherein
said external interface unit has a connection detection unit for detecting connecting state of said external device, and
said power supply unit interrupts the power supply to said external interface unit in the subsequent power saving mode on the basis of detection result of said connection detection unit in the normal power mode.

4. The multi-function printer according to claim 3, wherein
said user setting storage unit stores the user setting information representing un-connection of said external device as a usage manner of the user,
said power supply unit interrupts the power supply to said external interface unit in the power saving mode and when said user setting information is set, and
said user setting information is reset automatically when connection to said external device is detected by said connection detection unit in the normal power mode.

5. The multi-function printer according to claim 3, wherein
said user setting storage unit stores user setting information representing un-connection of said external device as a usage manner of the user,
said power supply unit interrupts the power supply to said external interface unit in the power saving mode and when said user setting information is set, and
a setting operation of said user setting information by the user is prohibited when connection to said external device is detected by said connection detection unit.
